(19) United States
(12) Patent Application Publication
(10) Pub. No.: US 2026/0200388 A1
(43) Pub. Date: Jul. 16, 2026

(54) DUMP TRUCK

(71) Applicant: KOMATSU LTD., Tokyo (JP)

(72) Inventor: Yuki ONO, Tokyo (JP)

(21) Appl. No.: 19/134,426

(22) PCT Filed: Dec. 18, 2023
(86) PCT No.: PCT/JP2023/045255

§ 371 Date: May 30, 2025

(30) Foreign Application Priority Data
Dec. 26, 2022 (JP) 2022-207846

(51) Int. Cl. B60P 1/28; B60K 13/02; B60K 13/04; F01N 3/02; F02B 29/04; F02M 35/024

(52) U.S. Cl. CPC B60P 1/28; B60K 13/02; B60K 13/04; F01N 3/0205; F02B 29/0406; F02M 35/024

(57) ABSTRACT

A dump truck includes a dump body, a drive source, and a duct. The dump body is rotatably coupled to a vehicle body frame and configured to carry a load. The drive source is configured to use hydrogen as fuel. The duct is configured to guide exhaust gas from the drive source to the dump body.

### CROSS-REFERENCE TO RELATED APPLICATIONS

This application is a U.S. National stage application of International Application No. PCT/JP2023/045255, filed on Dec. 18, 2023. This U.S. National stage application claims priority under 35 U.S.C. § 119(a) to Japanese Patent Application No. 2022-207846, filed in Japan on Dec. 26, 2022, the entire contents of which are hereby incorporated herein by reference.

### BACKGROUND

### Technical Field

The present invention relates to a dump truck.

### Background Information

In transporting objects that contain a lot of moisture in a cold region or the like, in some cases, work efficiency decreases due to freezing of a load. For example, there are two means (loading platform heating mechanisms) for solving the above problems.
(1) A loading platform heating mechanism that sends exhaust gas from an engine to a loading platform.
(2) A loading platform heating mechanism that utilizes heat generated by a retarder brake. A retarder brake is a dynamic brake in an electrically driven dump truck that operates an electric motor as a generator during braking and obtains a braking force by consuming a regenerative electromotive force of the electric motor through a resistor.

For example, JP 2012-201227 A discloses a dump truck that includes a loading platform, a resistor, a cooling fan, and a duct. The resistor converts electric power generated by retarder braking into thermal energy. The cooling fan cools the resistor. The duct guides the warm air that is blown by the cooling fan and heated by the resistor. A passage is formed in the loading platform to allow the warm air guided by the duct to circulate inside.

### SUMMARY

When exhaust gas from an engine is sent to the loading platform, the components contained in the exhaust gas can cause corrosion and soot on the loading platform, making maintenance very difficult. In using the heat generated by the retarder brake, a separate cooling fan needs to be installed to blow warm air. Therefore, there is room for improvement in terms of improving maintainability and simplifying the system while suppressing decrease in work efficiency due to freezing of a load.

Therefore, an object of the present invention is to provide a dump truck that can improve maintainability and simplify the system while suppressing decrease in work efficiency due to freezing of a load.

A dump truck according to one aspect of the present invention is a dump truck including a dump body that is rotatably coupled to a vehicle body frame and that carries a load, and further includes a drive source that uses hydrogen as fuel, and a duct that guides exhaust gas from the drive source to the dump body.

According to the above aspect, it is possible to improve maintainability and simplify the system while suppressing decrease in work efficiency due to freezing of the load.

### BRIEF DESCRIPTION OF DRAWINGS

FIG. 1 is a side view of a dump truck according to an embodiment.

FIG. 2 is a side view of the dump truck according to the embodiment when a load is being discharged.

FIG. 3 is a block diagram of a loading platform heating system according to the embodiment.

### DETAILED DESCRIPTION OF EMBODIMENT(S)

Hereinafter, an embodiment of the present invention will be described with reference to the drawings. In the embodiment, a dump truck, which is a transport vehicle that travels through a work site such as a mine to transport a load, will be described as an example of a work vehicle including a loading platform heating system.

### Dump Truck

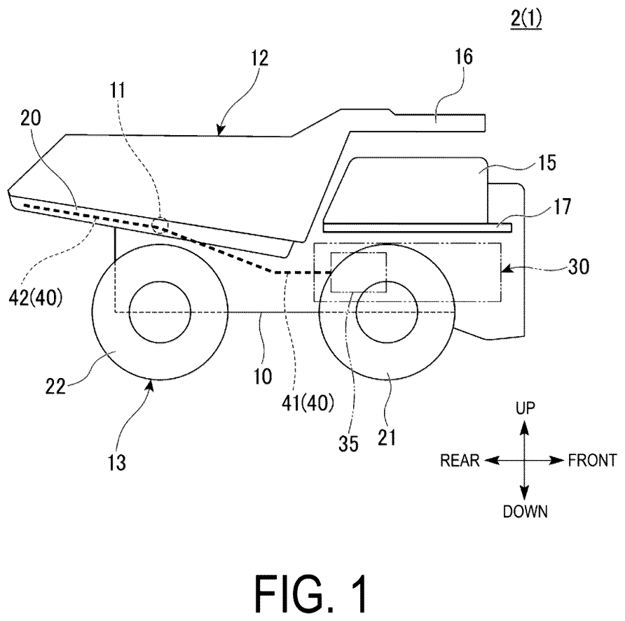

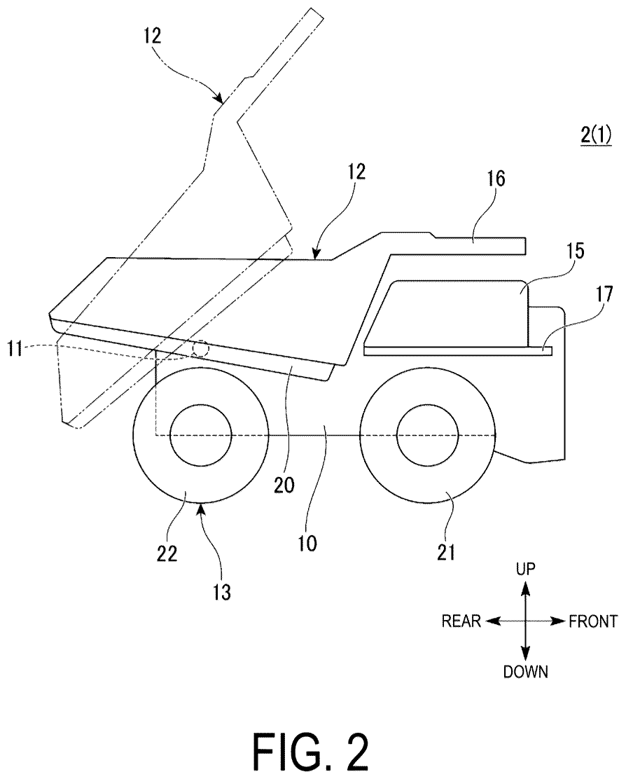

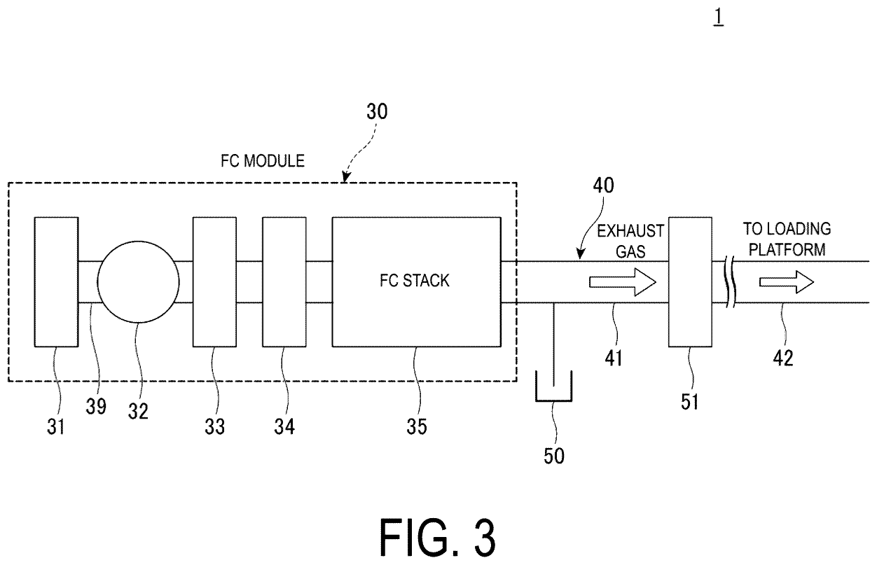

FIG. 1 is a side view of a dump truck 2 according to an embodiment. FIG. 2 is a side view of the dump truck 2 according to the embodiment when a load is being discharged. FIG. 3 is a block diagram of a loading platform heating system 1 according to the embodiment.

Referring to FIGS. 1 to 3 together, the dump truck 2 includes a vehicle body frame 10, a dump body 12 (corresponding to a vessel) that is rotatably coupled to the vehicle body frame 10 and that carries a load, and a traveling device 13 that supports the vehicle body frame 10. For example, the dump truck 2 may be an unmanned dump truck that is driven without being driven by a driver, or may be a manned dump truck that is driven based on the driving operation by a driver.

Hereinafter, a forward direction (forward from the vehicle body), a reverse direction (rearward from the vehicle body), and a vehicle width direction (left and right direction of the vehicle body) of the dump truck 2 are referred to as “forward in the vehicle (one side in a front-rear direction of the vehicle)”, “rearward in the vehicle (the other side in the front-rear direction of the vehicle)”, and a “vehicle width direction”, respectively. The vehicle width direction may also be referred to as a “left side (one side in the vehicle width direction)” or a “right side (the other side in the vehicle width direction)”. The right-hand side with respect to the forward movement direction of the dump truck 2 is referred to as the right side, and the left-hand side with respect to the forward movement direction of the dump truck 2 is referred to as the left side. A vehicle up-down direction (vehicle body up-down direction), a vehicle upper side (vehicle body top), and a vehicle lower side (vehicle body bottom) of the dump truck 2 are simply referred to as an “up-down direction”, “upper”, and “lower”. In the illustrated example, the dump truck 2 is disposed on a horizontal plane (horizontal ground). The vehicle up-down direction (vehicle body up-down direction), the vehicle upper side (vehicle body top), and the vehicle lower side (vehicle body bottom) of the dump truck 2 respectively correspond to the up-down direction (vertical direction), the vertical upper side, and the vertical lower side in a state in which the dump truck 2 is disposed on a horizontal plane.

The vehicle body frame 10 extends in the front-rear direction of the vehicle. The vehicle body frame 10 rotatably supports the dump body 12 via a rotating portion 11. The rotating portion 11 is a portion that includes an axis portion (corresponding to a rotating center axis of the dump body 12) that extends in the vehicle width direction on the vehicle body frame 10. The vehicle body frame 10 is supported by the traveling device 13.

The dump body 12 is rotatably coupled to the vehicle body frame 10 at the rotating portion 11. The dump body 12 is a member on which a load is carried (corresponding to a loading platform). At least a portion of the dump body 12 is disposed above the vehicle body frame 10. The dump body 12 can perform dumping operation and lowering operation.

The dumping operation is operation of moving the dump body 12 away from the vehicle body frame 10 and tilting the dump body in a dumping direction. The dumping direction is toward the rear of the vehicle body frame 10. In an embodiment, the dumping operation includes raising the front end of the dump body 12 and tilting the dump body 12 rearward. During the dumping operation, the loading surface of the dump body 12 tilts downward toward the rear.

The lowering operation is operation of bringing the dump body 12 closer to the vehicle body frame 10. The lowering operation is operation in the opposite direction to the dumping operation. In an embodiment, the lowering operation includes lowering the front end of the dump body 12.

By the dumping operation and the lowering operation, the dump body 12 is adjusted to a dumping posture and a loading posture. The dumping posture is a posture in which the dump body 12 is raised. The loading posture is a posture in which the dump body 12 is lowered. In the example of FIG. 2, the dump body 12 in the loading posture is indicated by a solid line, and the dump body 12 in the dumping posture is indicated by a two-dot chain line.

For example, in performing soil discharge work, the dump body 12 performs dumping operation to change from a loading posture to a dumping posture. When a load is loaded on the dump body 12, the load is discharged rearward from the rear end of the dump body 12 by the dumping operation. On the other hand, when loading work is performed, the dump body 12 is adjusted to the loading posture.

The dump body 12 is provided with a protector 16 that protects a cab 15 from above. The protector 16 is disposed to cover the cab 15 from above when the dump body 12 is in the loading posture. The protector 16 is provided on the front-end side of the dump body 12. The protector 16 is disposed above the cab 15. The protector 16 extends in the vehicle width direction. For example, the cab 15 is disposed to the left of the center in the vehicle width direction.

The cab 15 is supported by a platform 17. The platform 17 is provided to ensure a foothold for an operator when getting into and out the cab 15. The platform 17 is provided to ensure a foothold when maintenance is performed on the equipment mounted on the dump truck 2. The platform 17 is disposed below the protector 16. The platform 17 is disposed above wheels 21 and 22. The platform 17 extends in the vehicle width direction. The platform 17 is formed in a plate shape that is parallel to the vehicle front-rear direction and the vehicle width direction.

The traveling device 13 supports the vehicle body frame 10. The traveling device 13 causes the dump truck 2 to travel. The traveling device 13 moves the dump truck 2 forward or backward. At least a portion of the traveling device 13 is disposed below the vehicle body frame 10. The traveling device 13 is equipped with a plurality of wheels 21 and 22. The plurality of wheels 21 and 22 include front wheels 21 and rear wheels 22 disposed rearward of the front wheels 21.

The front wheels 21 are steered wheels that are steered to change the traveling direction of the dump truck 2. The front wheels 21 are disposed in a pair on the left and right. The pair of left and right front wheels 21 are disposed at a distance from each other in the vehicle width direction via the front part of the vehicle body frame 10. The front wheels 21 are provided on the left and right sides, respectively (two in total).

The rear wheels 22 are drive wheels driven by a drive source 35. The rear wheels 22 are disposed in a pair on the left and right. The pair of left and right rear wheels 22 are disposed at a distance from each other in the vehicle width direction via the rear part of the vehicle body frame 10. Two of the rear wheels 22 are provided on the left and right sides, respectively (four in total).

The dump truck 2 further includes a drive source 35 that uses hydrogen as fuel, and a duct 40 that guides exhaust gas from the drive source 35 to the dump body 12. The drive source 35 and the duct 40 constitute the loading platform heating system 1 (an example of a system).

### Loading Platform Heating System

The components of the loading platform heating system 1 are mounted on the vehicle body frame 10 and the dump body 12. The loading platform heating system 1 includes a filter 31, a compressor 32, an intercooler 33, a humidifier 34, a drive source 35 (corresponding to an FC stack), an air introduction pipe 39, a duct 40, a tank 50, and a heat exchanger 51.

The filter 31, the compressor 32, the intercooler 33, the humidifier 34, the drive source 35, the air introduction pipe 39, and a portion of the duct 40 constitute an FC module 30. The FC module 30 is mounted on the vehicle body frame 10. A portion of the duct 40 is mounted on the dump body 12.

The filter 31 is provided upstream of the drive source 35. For example, the filter 31 is an air filter for purifying the air to be supplied to the drive source 35. For example, the filter 31 may be configured by a dust filter, a chemical filter, or the like. For example, the configuration mode of the filter 31 can be changed according to design specifications.

For example, the filter 31 may be provided at the furthest upstream position in the FC module 30. For example, air outside the FC module 30 (outside air) passes through the filter 31 and then enters the air introduction pipe 39. Accordingly, it is possible to purify the air to be supplied to the drive source 35 from the upstream side of the FC module 30.

The compressor 32 is provided downstream of the filter 31 and upstream of the drive source 35. The compressor 32 is a device for compressing the air to be supplied to the drive source 35. The compressor 32 is provided in a portion of the air introduction pipe 39 between the filter 31 and the drive source 35. Accordingly, the air that has passed through the filter 31 is compressed, and thus purified compressed air can be supplied to the drive source 35.

The intercooler 33 is provided downstream of the compressor 32 and upstream of the drive source 35. The intercooler 33 is a device for cooling the air compressed by the compressor 32. The compressor 32 is provided in a portion of the air introduction pipe 39 between the compressor 32 and the drive source 35. Accordingly, the compressed air from the compressor 32 is cooled, and thus decrease in relative humidity (the amount of water vapor contained in the air flowing through the air introduction pipe 39) due to overheating of the compressed air from the compressor 32 can be suppressed.

The humidifier 34 is provided downstream of the intercooler 33 and upstream of the drive source 35. The humidifier 34 is a device for humidifying the air to be supplied to the drive source 35. The humidifier 34 is provided in a portion of the air introduction pipe 39 between the intercooler 33 and the drive source 35. Accordingly, the air from the intercooler 33 is humidified, and thus the relative humidity of the air to be supplied to the drive source 35 can be maintained at a predetermined humidity.

For example, among fuel cells (an example of the drive source 35), the electrolyte membrane of a polymer electrolyte fuel cell, a phosphoric acid fuel cell, or the like needs to contain water in order to conduct electricity. For example, the humidifier 34 is configured to maintain a required relative humidity for the electrolyte membrane.

The drive source 35 is provided at the downstream end of the air introduction pipe 39. The drive source 35 includes a fuel cell (FC) that generates electricity by chemically reacting hydrogen, which is a fuel gas, with oxygen, which is an oxidizing gas. For example, a fuel cell has a stack structure in which a plurality of unit cells are stacked. For example, fuel cells generate electricity using oxygen contained in the outside air. The fuel cell may be supplied with air containing oxygen by an oxidizing gas supply device (not shown).

The drive source 35 of the present embodiment includes a polymer electrolyte fuel cell as a fuel cell. Typically, the temperature of exhaust gas from a polymer electrolyte fuel cell is 60 degrees to 80 degrees. Therefore, the dump body 12 is unlikely to overheat due to the heat of the exhaust gas. In the present embodiment, a separate cooling device for cooling the exhaust gas from the drive source 35 is not provided.

Typically, the exhaust pressure of a fuel cell is 200 kPa to 300 kPa, which is higher than atmospheric pressure. Therefore, the system can be constructed without using a cooling fan or the like.

The drive source 35 may include a hydrogen engine, which is an internal combustion engine that uses hydrogen as fuel. For example, a hydrogen engine may generate power to perform the dumping operation or the lowering operation of the dump body 12. For example, a hydrogen engine may generate power to steer the front wheels 21. For example, the power (rotational force) generated by the hydrogen engine may be transmitted to the rear wheels 22 of the traveling device 13.

In addition, the loading platform heating system 1 may include a hydrogen filling system for filling a hydrogen tank 60 with hydrogen as fuel, and a hydrogen supply system for supplying the hydrogen in the hydrogen tank 60 to the drive source 35. For example, the hydrogen tank 60 may be mounted on the vehicle body frame 10. For example, the hydrogen filling system and the hydrogen supply system may be mounted on the vehicle body frame 10.

The dump truck 2 may include a battery (for example, a secondary battery such as a lithium-ion battery). For example, a battery stores the electric power generated in a fuel cell. For example, a battery may serve as a power source for the dump truck 2, similarly to a fuel cell.

### Duct

The duct 40 is a pipe that guides the exhaust gas from the drive source 35 to the dump body 12. In the present embodiment, at least a portion of the duct 40 is provided in the dump body 12. The duct 40 includes a first piping portion 41 provided in the vehicle body frame 10 and a second piping portion 42 provided in the dump body 12.

The upstream end of the first piping portion 41 is connected to the drive source 35. For example, the first piping portion 41 extends from the drive source 35 to the vicinity of the rotating portion 11. For example, the portion of the duct 40 that couples the first piping portion 41 and the second piping portion 42 at the vicinity of the rotating portion 11 may be configured to be flexible or expandable.

The second piping portion 42 is provided in the dump body 12. The dump body 12 includes a rib 20 along one surface of the dump body 12. For example, the rib 20 serves as a reinforcing member for the dump body 12. The second piping portion 42 (corresponding to at least a portion of the duct 40) is provided along the rib 20. For example, the rib 20 may have a rectangular cross-sectional shape. For example, the second piping portion 42 may be disposed in the internal space of the rib 20.

In the example of FIG. 1, the rib 20 is provided along the side edge of the lower surface of the dump body 12 (an example of one surface of the dump body 12). For example, a plurality of ribs 20 may be provided on the lower surface of the dump body 12. For example, the ribs 20 may be provided on the front surface and the left and right side surfaces (surfaces other than the lower surface) of the dump body 12. For example, the installation mode of the ribs 20 can be changed according to design specifications.

In the example of FIG. 1, the second piping portion 42 is provided within the rib 20 along the side edge of the lower surface of the dump body 12. In the present embodiment, the second piping portion 42 (a portion of the duct 40) is installed by utilizing the existing rib 20 of the dump body 12. In the present embodiment, separate ribs (new ribs) other than the existing ribs 20 are not provided.

### Tank

The tank 50 is a container for collecting water generated by exhaust gas from the drive source 35. The tank 50 is provided downstream of the drive source 35. The tank 50 is provided in a portion of the first piping portion 41 between the drive source 35 and the rotating portion 11. The tank 50 is mounted on the vehicle body frame 10.

### Heat Exchanger

The heat exchanger 51 is a device for exchanging heat with the exhaust gas from the drive source 35. The heat exchanger 51 is provided downstream of the drive source 35. The heat exchanger 51 is provided in a portion of the first piping portion 41 between the tank 50 (specifically, the portion branching from the first piping portion 41 to the tank 50) and the rotating portion 11. The heat exchanger 51 is mounted on the vehicle body frame 10. For example, the heat exchanger 51 may be configured to reduce the temperature of the exhaust gas by adiabatic expansion of the air.

Note that the heat exchanger 51 is not limited to being mounted on the vehicle body frame 10. For example, the dump body 12 itself may serve as the heat exchanger 51. Accordingly, the exhaust gas from the drive source 35 is cooled, and thus the dump body 12 can be prevented from overheating due to the heat of the exhaust gas.

### Arrangement of System Components

Also referring to FIG. 1, the FC module 30 is disposed forward of the lower front end of the dump body 12. The FC module 30 is disposed below the platform 17.

The FC module 30 is mounted on the vehicle body frame 10. The FC module 30 is preferably disposed within the range of the vehicle width direction of the vehicle body frame 10. Accordingly, the FC module 30 is covered by the vehicle body frame 10 from below the vehicle body. Therefore, it is possible to prevent disturbances (such as flying stones) from reaching the FC module 30 from below the vehicle body.

### Actions and Effects

As described above, the dump truck 2 of the present embodiment includes the dump body 12 that is rotatably coupled to the vehicle body frame 10 and that carries a load. The dump truck 2 further includes the drive source 35 that uses hydrogen as fuel, and the duct 40 that guides exhaust gas from the drive source 35 to the dump body 12.

According to this configuration, the duct 40 guides the exhaust gas from the drive source 35 that uses hydrogen as fuel to the dump body 12. Therefore, it is possible to suppress decrease in work efficiency due to the freezing of the load, by the heat of the exhaust gas. In addition, the exhaust gas from the drive source 35 that uses hydrogen as fuel is cleaner than the exhaust gas from an engine, which improves the ease of maintainability against corrosion, soot, etc. In addition, since the exhaust pressure of the drive source 35 that uses hydrogen as fuel is higher than atmospheric pressure, there is no need to provide a separate cooling fan for blowing warm air. Therefore, it is possible to improve maintainability and simplify the system while suppressing decrease in work efficiency due to freezing of the load.

In the present embodiment, at least a portion of the duct 40 is provided in the dump body 12.

According to this configuration, the heat of the exhaust gas is more easily transferred to the dump body 12 than when the entire duct 40 is provided in a member separate from the dump body 12. Therefore, it is possible to more effectively suppress decrease in work efficiency due to the freezing of the load.

In the present embodiment, the dump body 12 includes a rib 20 along one surface of the dump body 12. At least a portion of the duct 40 is provided along the rib 20.

According to this configuration, since the heat of the exhaust gas is transferred to one surface of the dump body 12 along the rib 20 of the dump body 12, decrease in work efficiency due to freezing of the load can be more effectively suppressed. In addition, when the duct 40 is installed using the existing rib 20 of the dump body 12, there is no need to provide a new rib separately, which allows further simplification.

For example, the rib 20 itself may serve as the duct 40. For example, the internal space formed by the bottom plate of the dump body and the rectangular rib may itself be used as the internal space of the duct 40 (the guide passage of the exhaust gas). This makes it easier to transfer heat compared to the case where a pipe that is a separate member from the rib 20 is used.

In the present embodiment, the drive source 35 includes a polymer electrolyte fuel cell.

According to this configuration, since the temperature of exhaust gas from a polymer electrolyte fuel cell is typically 60 degrees to 80 degrees, the likelihood of the dump body 12 being overheated by the heat of the exhaust gas is low. Therefore, there is no need to provide a separate cooling device for cooling the exhaust gas from the drive source 35, which allows further simplification.

Typically, the temperature of exhaust gas from a solid oxide fuel cell is 800 degrees to 1000 degrees, the temperature of exhaust gas from a phosphoric acid fuel cell is 190 degrees to 200 degrees, and the temperature of exhaust gas from a molten carbonate fuel cell is 600 degrees to 700 degrees. According to the present embodiment, since the drive source 35 includes a polymer electrolyte fuel cell, the likelihood of the dump body 12 being overheated due to the heat of the exhaust gas is low compared to the case where the drive source 35 is equipped with the above-mentioned solid oxide fuel cell or the like.

In the present embodiment, the dump truck 2 further includes the filter 31 that is provided upstream of the drive source 35 and that purifies the air to be supplied to the drive source 35.

According to this configuration, since the air to be supplied to the drive source 35 passes through the filter 31, the exhaust gas from the drive source 35 can be further purified. Therefore, the ease of maintainability can be further improved.

In the present embodiment, the dump truck 2 further includes the compressor 32 that is provided upstream of the drive source 35 and that compresses air to be supplied to the drive source 35, and the intercooler 33 that is provided between the compressor 32 and the drive source 35 and that cools the air compressed by the compressor 32.

According to this configuration, since the compressed air from the compressor 32 is cooled by the intercooler 33, decrease in relative humidity due to overheating of the compressed air from the compressor 32 can be suppressed. Therefore, the performance degradation of the drive source 35 caused by the decrease in relative humidity can be suppressed.

In the present embodiment, the dump truck 2 further includes the humidifier 34 that is provided upstream of the drive source 35 and that humidifies the air to be supplied to the drive source 35.

According to this configuration, the air to be supplied to the drive source 35 is humidified by the humidifier 34, and thus the performance of the drive source 35 can be improved.

In the present embodiment, the dump truck 2 further includes the tank 50 for collecting water generated by the exhaust gas.

According to this configuration, the water generated by the exhaust gas is collected in the tank 50, and thus the collected water can be utilized.

In the present embodiment, the dump truck 2 further includes the heat exchanger 51 that exchanges heat with the exhaust gas.

According to this configuration, the exhaust gas is cooled by the heat exchanger 51, and the dump body 12 can be prevented from overheating due to the heat of the exhaust gas.

Moreover, the heat exchanged in the heat exchanger 51 may be utilized in another portion. For example, in cells with high exhaust temperatures, such as solid oxide fuel cells, the exhaust heat can be collected and used to turn it into hot water.

### Modification Example

In the above-described embodiment, an example has been described in which at least a portion of the duct is provided in the dump body, but is not limited thereto. For example, the entire duct may be provided in a member separate from the dump body. For example, the installation mode of the duct can be changed according to the design specifications.

In the above-described embodiment, an example has been described in which the dump body includes a rib along one surface of the dump body, but is not limited thereto. For example, the dump body may not include a rib. For example, the installation mode of the rib can be changed according to the design specifications.

In the above-described embodiment, an example has been described in which at least a portion of the duct is provided along the rib, but is not limited thereto. For example, at least a portion of the duct may be provided along one surface of the dump body. For example, the installation mode of the duct relative to the dump body can be changed according to the design specifications.

In the above-described embodiment, an example has been described in which the drive source includes a polymer electrolyte fuel cell, but is not limited thereto. For example, the drive source may not include a polymer electrolyte fuel cell. For example, the drive source may include a solid oxide fuel cell, a phosphoric acid fuel cell, or a molten carbonate fuel cell. For example, the configuration mode of the drive source can be changed according to the design specifications.

In the above-described embodiment, an example has been described in which the dump truck further includes a filter that is provided upstream of the drive source and that purifies the air to be supplied to the drive source, but is not limited thereto. For example, the dump truck may not include a filter. For example, the installation mode of the filter can be changed according to the design specifications.

In the above-described embodiment, an example has been described in which the dump truck further includes a compressor that is provided upstream of the drive source and that compresses air to be supplied to the drive source, and an intercooler that is provided between the compressor and the drive source and that cools the air compressed by the compressor, but is not limited thereto. For example, the dump truck may not include an intercooler. For example, the installation mode of the intercooler can be changed according to the design specifications.

In the above-described embodiment, an example has been described in which the dump truck further includes a humidifier that is provided upstream of the drive source and that humidifies the air to be supplied to the drive source, but is not limited thereto. For example, the dump truck may not include a humidifier. For example, the installation mode of the humidifier can be changed according to the design specifications.

In the above-described embodiment, an example has been described in which the dump truck further includes a tank for collecting water generated by the exhaust gas, but is not limited thereto. For example, the dump truck may not include a tank. For example, the installation mode of the tank can be changed according to the design specifications.

In the above-described embodiment, an example has been described in which the dump truck further includes a heat exchanger that exchanges heat with the exhaust gas, but is not limited thereto. For example, the dump truck may not include a heat exchanger. For example, the installation mode of the heat exchanger can be changed according to the design specifications.

Although the embodiments of the present invention have been described above, the present invention is not limited to these, and additions, omissions, substitutions, and other modifications of the configuration are possible without departing from the spirit of the present invention, and the above-described embodiments can also be combined as appropriate.

1. A dump truck comprising:
a dump body rotatably coupled to a vehicle body frame and configured to carry a load;
a drive source configured to use hydrogen as fuel; and
a duct configured to guide exhaust gas from the drive source to the dump body.

2. The dump truck according to claim 1, wherein
at least a portion of the duct is provided in the dump body.

3. The dump truck according to claim 2, wherein
the dump body includes a rib along one surface of the dump body, and
at least a portion of the duct is provided along the rib.

4. The dump truck according to claim 1, wherein
the drive source includes a polymer electrolyte fuel cell.

5. The dump truck according to claim 1, further comprising:
a filter provided upstream of the drive source and configured to purify air to be supplied to the drive source.

6. The dump truck according to claim 1, further comprising:
a compressor provided upstream of the drive source and configured to compress air to be supplied to the drive source; and
an intercooler provided between the compressor and the drive source and configured to cool the air compressed by the compressor.

7. The dump truck according to claim 1, further comprising:
a humidifier provided upstream of the drive source and configured to humidify air to be supplied to the drive source.

8. The dump truck according to claim 1, further comprising:
a tank configured to collect water generated by the exhaust gas.

9. The dump truck according to claim 1, further comprising:
a heat exchanger configured to exchange heat with the exhaust gas.
